(19) United States
(12) Patent Application Publication
(10) Pub. No.: US 2011/0216903 A1
(43) Pub. Date: Sep. 8, 2011

(54) METHOD AND DEVICE FOR EMITTING MESSAGES FOR GUARANTEEING THE AUTHENTICITY OF A SYSTEM AND METHOD AND DEVICE FOR VERIFYING THE AUTHENTICITY OF SUCH A SYSTEM

(76) Inventors: Dominique Curabet, Paris (FR); Frédéric Rousseau, Montigny Le Bretonneux (FR)

(21) Appl. No.: 12/993,327

(22) PCT Filed: May 4, 2009
(86) PCT No.: PCT/FR09/50809

§ 371 Date: May 24, 2011

(30) Foreign Application Priority Data
May 19, 2008 (FR) 0802694

(51) Int. Cl. H04W 12/06

(52) U.S. Cl. 380/270

(57) ABSTRACT

The invention relates to a method for emitting messages in order to guarantee the authenticity of the system that emitted said messages. The method includes the following steps, namely: a step comprising the selection of a threshold value used in a threshold-based cryptographic scheme, which value is greater than or equal to 1;—a step comprising the generation of a set of partial information items, such that knowledge of a number i, greater than or equal to the threshold value K, of partial information items can be used to verify a signature of at least part of the messages; and a fourth step comprising the sending of each partial information item separately in a distinct message. The invention also relates to a device for emitting messages for guaranteeing the authenticity of the system that emitted the messages, as well as to a method and a device for verifying the authenticity of such a system. In particular, the invention is suitable for global satellite-based radiocommunication and radionavigation systems.

The invention relates to a method and device for transmitting messages to guarantee the authenticity of a system that transmitted said messages, as well as a method and device for verifying the authenticity of a system that transmitted messages. In particular, the invention especially applies to radio navigation systems and radio communication systems.

There are numerous critical systems comprising a plurality of transmitters broadcasting different signals simultaneously. Adapted receivers receive and use a plurality of these signals transmitted by some of the transmitters at a given time in their normal operating mode. Simulcast trunked radio systems, digital video broadcasting (DVB) or also transponder systems like the automatic dependent surveillance-broadcast system, can be cited by way of example. Land-based radio navigation infrastructures, such as the LORAN (LOng-RAnge Navigation) system, which broadcasts signals on VHF carriers on a data channel (generally referred to as a low data channel (LDC) or EUROFIX, according to the different versions), also use a plurality of transmitters broadcasting signals simultaneously. Global satellite navigation systems can also be mentioned, such as the global positioning system (more commonly referred to by the acronym GPS). More particularly, in satellite radio navigation systems using the European Geostationary Navigation Overlay Service (EGNOS), radio frequency identification tags are broadcast in such a way that a receiver can determine the signal power and distance parameters, as well as the navigation signals enabling it to calculate its position, speed and absolute time. This data is liable to be corrupted by scrambling and/or falsification means, or even simply degraded by noise and interference.

In order to guarantee a level of security adapted to the criticality of the application, the use of a combination of cryptographic techniques is known in the art, which protect transmission channels (generally referred to using the acronym TRANSEC, standing for TRANSmission SECurity), and/or cryptographic techniques which protect transmitted data (generally referred to using the acronym INFOSEC, standing for INFOrmation SECurity or COMSEC, standing for COMmunication SECurity). For example, the regulated public service of the GALILEO satellite radio navigation system uses a spread spectrum method based on a code sequence generated from a cryptographic key (TRANSEC) and a method of encrypting navigation methods (COMSEC).

However, these means of protection only guarantee that a set of signals definitely comes from a set of genuine transmitters belonging to the system at the cost of transmitting a relatively significant quantity of additional authentication information in relation to the bandwidth available (in the order of 320 non-repudiable signature bits per message in a radio navigation system that may have a throughput of 50 bit/sec, using asymmetrical cryptography, such as the Safety-of-Life service of the GALILEO satellite radio navigation system) or else at the cost of transmitting an additional authentication information item which is short but associated with a secret shared by all receivers and by the transmitters, the validation associated with this secret not being able to be demonstrated to third parties without revealing said secret to these third parties (in a system using symmetrical cryptography such as the GALILEO satellite radio navigation system guaranteeing a commercial service and a regulated public service). It is not therefore possible in the prior art to create an effective trust chain in a low bandwidth system, making it possible to prove to third parties that messages received by a system receiver are guaranteed to have come from genuine system transmitters.

The particular aim of the invention is to overcome the aforementioned disadvantages. To this end, the object of the invention is a method of transmitting messages to guarantee the authenticity of the system that transmitted said messages MSG. The method also includes:
a second stage for selecting a threshold value K greater than or equal to 1;
a third stage for generating a set of partial information items, such that knowledge of a number i of partial information items greater than or equal to the threshold value K makes it possible to verify a signature of at least part of the messages;
a fourth stage for sending each partial information item separately in one of the distinct messages MSG.

Each partial information item may also include redundant data to detect and/or suppress transmission errors.

In a first embodiment of the transmission method, the partial information items are partial keys generated such that knowledge of a number i of partial keys greater than or equal to the threshold value K enables a public key to be reconstructed. The signature it produced to be verifiable in relation to said public key. Each message MSG includes the signature of at least part of the said message MSG.

In a second embodiment, the partial information items are parts of the signature, such that knowledge of a number i of parts of the signature greater than or equal to the threshold value K enables the signature to be reconstructed. The signature is linked to the system and/or to at least part of the messages MSG common to the set of messages MSG over a given period.

Another object of the invention is a method of verifying the authenticity of a system that transmitted messages MSG liable to be obtained by the transmission method according to the invention. It particularly includes:
a fifth stage for receiving messages MSG including partial information items;
a sixth stage for using the number j of partial information items received during the course of the fifth stage to reconstruct information items enabling a signature of at least part of the messages MSG to be verified;
if it has been possible to complete the sixth stage, a seventh stage for verifying the signature of the messages MSG.

Another object of the invention is a transmission device adapted to the implementation of the transmission method according to the invention. It includes means of constructing and sending messages MSG. Each message MSG includes at least a partial information item of a set generated so that knowledge of a number i of partial information items greater than or equal to a threshold value K makes it possible to verify a signature of at least part of the messages MSG.

In a first embodiment of the transmission device, the partial information items are partial keys, for which knowledge of a number i greater than or equal to the threshold value K makes it possible to reconstruct a public key, the signature being verifiable in relation to said public key. Each message MSG includes the signature of at least part of said message MSG.

In a second embodiment of the transmission device, the partial information items are parts of the signature, for which knowledge of a number i greater than or equal to the threshold value K makes it possible to reconstruct the signature. The signature is linked to the system and/or to at least part of the messages MSG common to the set of messages MSG over a given period.

Another object of the invention is a device for verifying the authenticity of a system adapted to the implementation of the verification method according to the invention. It includes:
decoding means adapted to receive messages MSG and extract partial information items from said messages MSG received;
means of reconstructing information items enabling at least one signature of at least part of the messages MSG to be verified from partial information items;
validation means adapted to verifying the validity of each signature extracted in relation to messages MSG received.

Another object of the invention is a satellite radio navigation system including transmission devices according to the invention and at least one verification device according to the invention.

Other characteristics and advantages of the invention will become more evident on reading the following description in relation to the attached drawings, which represent:

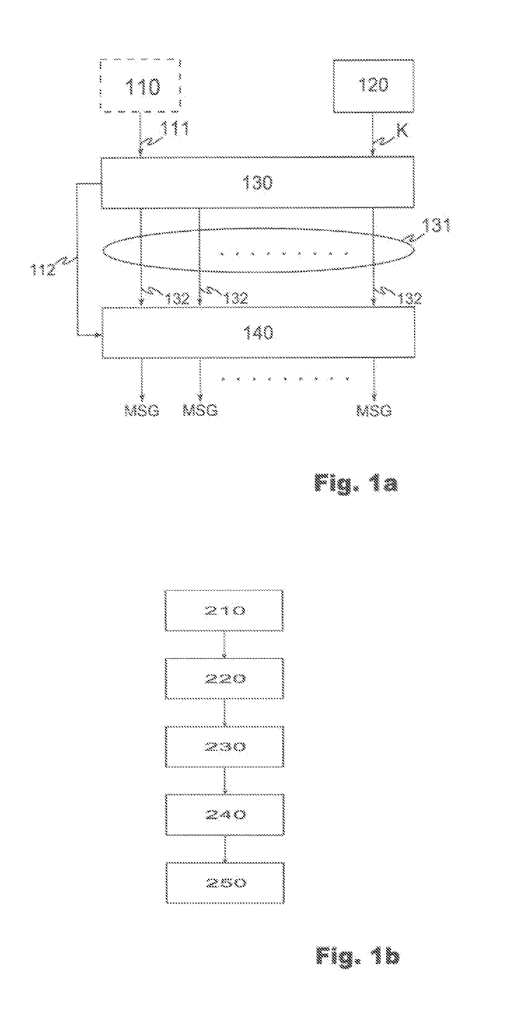

FIG. 1a, a block diagram of a method according to the invention of transmitting messages to guarantee the authenticity of a system that transmitted said messages;

FIG. 1b, a block diagram of a method according to the invention of verifying the authenticity of a system that transmitted messages;

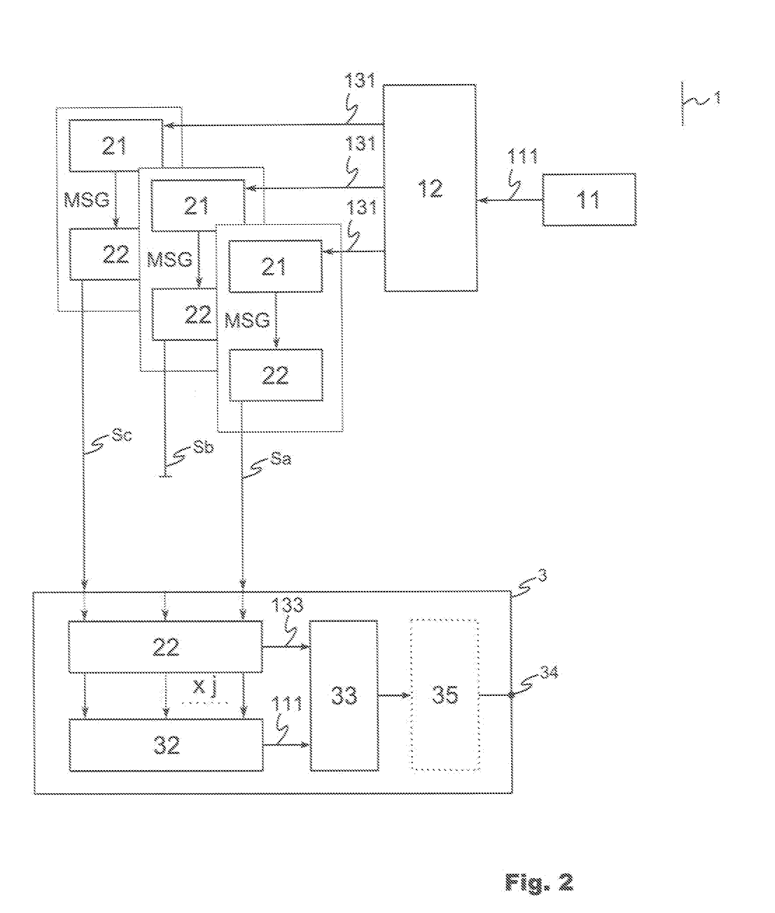

FIG. 2, a diagram of a system including transmission devices according to the invention and a device according to the invention for verifying the authenticity of a system that transmitted messages.

FIG. 1a illustrates by means of a block diagram a method according to the invention for transmitting messages to guarantee the authenticity of a system that transmitted said messages. The transmission method according to the invention may optionally include a first stage 110 for generating a public key 111/private key 112 pairing. The generation of a public key/private key pairing is well known to the person skilled in the art as having formed the basis of asymmetrical cryptography since the invention of the RSA algorithm by Rivest, Shamir and Adelman in 1978. Alternatively, the public key 111/private key 112 pairing may be received as access to the transmission procedure according to the invention or it may be a configurable parameter of the transmission procedure according to the invention.

In a second stage (120) of the method according to the invention, a threshold value K is selected. This threshold value K is a natural number at least equal to 1. The bigger the threshold value K, the greater the processing that may be necessary in order for a device receiving messages to generate a validation, all things being otherwise equal; the greater the threshold value K, the lower the bandwidth needed for authentication by the transmitter: it is therefore advisable for this threshold value K to be adapted bearing in mind these parameters and the constraints weighing on the device implementing the transmission method according to the invention and on the device implementing the verification method according to the invention.

In a third stage 130 of the method according to the invention, a set 131 of partial information items 132 is generated, either from the public key 111 or from the private key 112, according to the selected threshold-based cryptographic scheme. In the present description, the key term must be included in its widest acceptance, including, for example, the key and its possible attributes and/or a sealed key and/or a key certificate.

According to a first generation modality using the public key 111, these partial information items enable the public key 111 itself to be reconstructed, these partial information items are then partial keys.

According to a second generation modality using the private key 112 according to the selected threshold-based cryptographic scheme, these partial information items make it possible to reconstruct a signature associated with an message MSG, said signature being capable of being verified with the public key 111 which is supposedly known.

A method of generating partial secrets is described, for example, in the document “How to share a secret, Communications of the ACM, 22-1979” on pages 612 to 613, applied to a secret key in symmetrical cryptography.

By way of example, a threshold-based cryptographic scheme is described in the document “Efficient threshold signature, multi-signature and blind signature scheme based on the Gap-Diffie-Hellman group signature, A Boldyreva, IACR eCrypt, August 2002” and also in the document “Short signatures from the Weil Pairing, Dan Boneh, Ben Lynn and Hovav Shacham, ASIACRYPT 2001, LNCS 2248” on pages 514 to 532. The cardinal number of the set 131 of partial information items must be greater than or equal to the selected threshold K.

For example, according to the first modality, if the public key 111 is 512 bits long and the selected threshold value K is equal to 4, the set 131 will include at least four partial keys, each being slightly larger than 128 bits. Each partial key includes a fragment of information 133 of the public key 111. Each partial key is constructed such that knowledge of a number i of partial keys, the number i being greater than or equal to the threshold value K, enables the public key 111 to be reconstructed. In a specific embodiment of the third stage 130, each partial key may include, apart from the information fragment 133, additional information items 134. For example, the supplementary information items 134 may be redundant data used for a transmission channel (TRANSEC), particularly enabling transmission errors to be detected and suppressed.

For example, according to the second modality, a set 131 of partial signatures is generated in accordance with the selected threshold-based cryptography scheme using the private key 112.

In a fourth stage 140 of the method according to the invention, in a given period T, each partial information item 132 is sent separately in a distinct message MSG.

In the first modality, each message MSG also includes a signature 133 of at least part of said message MSG produced with the help of the private key 112. In this first modality, the signature 133 is linked to at least part of said message MSG.

In the second modality, partial information 132 sent in a message relates to a part-signature 133 of a threshold-based cryptographic scheme associated with data for the system transmitting the messages and produced with the help of the private key 112. In this second modality, the signature 133 is linked to the system and/or possibly to at least part of said message MSG which is common to the set of messages over a period T (for example, joint time-stamping of the simultaneous transmission of said distinct messages MSG).

In a third modality implementing two threshold-based cryptographic schemes (for example, according to a first modality, a secret sharing scheme applied to a key 111 and according to a second modality a threshold-based cryptographic signature scheme 133), the first and second modalities are implemented in the system to transmit a public key 111 and transmit a signature 133 produced with the help of the private key 112.

Of course each message MSG, and therefore the partial information 132 that it includes, may be sent:
encapsulated or not in any type of frame;
unencrypted or else in an encoded form for the purposes of encryption and/or compression and/or error correction.

The transmission method according to the invention makes it possible, in particular, for the sending of each partial information item 132 to be shared over several transmission channels. One advantage in this case is that the amount of information transmitted by the transmission channel is less with a partial key than that necessary in the prior art, while the key can be reconstructed from different partial keys. The distinct messages MSG may be transmitted in sequence via a transmission channel (such as a radio broadcasting channel) and/or transmitted simultaneously via different transmission channels (for example, by frequency-division multiple access or by code division multiple access, for example CDMA multiplexing) and/or a combination of the preceding cases. These message transmissions are known to the person skilled in the art, for example by reference to the interface specification “GALILEO Signal-In-Space Interface Control Document (Galileo SISICD)”.

FIG. 1b illustrates by means of a block diagram a method according to the invention of verifying the authenticity of a system that has transmitted messages liable to be obtained by the transmission method according to the invention. Elements already referred to in the other figures have the same reference numbers. The verification method according to the invention includes a fifth stage 150 for receiving messages MSG. The messages MSG include partial information items 132 (as well as the signature 133 of the message MSG according to the first modality). It is thereby possible that the set 131 of partial information items 132 is not received in full, but only a number j of partial information items 132. The verification method according to the invention includes a sixth stage 160, during the course of which complete, aggregated information—namely, the public key 111 in the first modality, the system signature in the second modality—is reconstructed from the number j of partial information items 132 received during the fifth stage 150. This sixth stage 160 can only succeed if the number j of partial information items 132 is greater than or equal to the threshold value K. If this is not the case, the sixth stage 160 fails and it is not then possible to guarantee the authenticity and integrity of the messages MSG received. The verification procedure according to the invention includes a seventh stage 170 in the method according to the invention, if it has been possible to reconstruct the complete, aggregated information during the sixth stage 160—namely, the public key 111 in the first modality, the system signature in the second modality—during the course of which each signature 133 is verified with the help of the public key 111—reconstructed in the first modality, supposedly previously known in the second modality.

FIG. 2 illustrates by means of a block diagram a system including transmission devices according to the invention and a device according to the invention for verifying the authenticity of a system that has transmitted messages. Elements already referred to in other figures have the same reference numbers.

System 1 according to the invention includes transmission devices 2 according to the invention transmitting signals S. Three transmitters are represented in FIG. 2 designated by the reference numbers 2a, 2b, 2c, respectively, each transmitting signals Sa, Sb and Sc, respectively. The transmitting devices 2 are not necessarily located in the same geographical zone. The signals S do not necessarily convey the same information. The system according to the invention includes at least one device according to the invention for verifying authenticity 3 according to the invention. In its nominal functioning mode, the device according to the invention for verifying authenticity 3 must receive a number of signals S at least equal to the threshold value K over a given period T. For example, if the threshold value K is equal to 2, it must receive in a given period at least two S signals from among the signals Sa, Sb and Sc.

The system according to the invention may include means of generating cryptographic keys 11. Means of generating cryptographic keys 11 make it possible, in particular, to generate a public key 111 and private key 112 pairing. Means of generating cryptographic keys 11 are therefore adapted to implementing the first stage 110 of the transmission procedure according to the invention. The system according to the invention may include means of generating partial information items 12 adapted to implementing the second stage 120 and the third stage 130 of the transmission procedure according to the invention. The means of generating partial information items 12 may be centralised or, alternatively, included in each transmission device 2. The means of generating partial information items 12 act in collaboration with the means of generating cryptographic keys 11. Therefore, according to a first modality, the means of generating partial information items 12 generate the set 131 of partial keys from the public key 111. As a result, the means of generating partial keys 12 implement a given threshold-based cryptographic scheme. The set 131 includes a number P of partial keys. Typically, the number P is equal to the number of signals S, or else three in the example in FIG. 2. However, according to the system configuration in particular, the number P may be lower than the number of signals S is certain partial keys are associated with several signals S. The number P may also be greater than the number of signals S if one wishes, for example, for a receiver 3 to have to receive several partial keys for the same signal S over a given period T in order to reconstruct the public key 111.

Each transmission device 2 itself includes means of constructing 21 an message MSG and means of broadcasting 22 said messages MSG. The messages MSG are sent via signals S, destined, for example, for the device according to the invention for verifying authenticity 3. For a given period T, each message MSG includes, for example, information common to all the transmission devices 2, information specific to each transmission device 2 at the start of said message, one or more partial information items 132 associated with the transmission device 2. According to a first modality, each message MSG furthermore includes a signature 133 relating to all or part of the message. According to a second modality, the partial information item or items 132 carried by the message MSG relates, for example, to a signature 133 for system information. Each partial information item 132 is associated with a system transmission device 2, or else possibly several transmission devices 2, if it is possible to guarantee, moreover, that a number of partial keys greater than or equal to the threshold value K may be received by each verification device 3 included in the system according to the invention. Alternatively, each message MSG may contain only part of the signature 133, the entire signature 133 being transmitted in several messages MSG over the course of the period T.

Each verification device 3 according to the invention includes at least message MSG decoding means 31. The decoding means 31 are especially adapted to decoding messages MSG. In particular, the decoding means 31 make it possible to extract from each message MSG shared information items, information items specific to the transmission device at the origin of said message MSG, partial keys 132 included in the message MSG and the signature 133. If the signature 133 is not fully transmitted in one and the same message MSG, the decoding means 131 gather together fragments linked to the SIGN signature received in several messages and reconstruct the complete SIGN signature through aggregation or interpolation from these fragments. The decoding means 31 receive and process all messages MSG included in all the signals S that the verification device 3 according to the invention may receive during the course of the given period T. Each verification device 3 according to the invention includes means of reconstructing 32 the complete, aggregated information (namely, the public key 111 in a first modality, the system signature in a second modality) working alongside the message MSG decoding means 31. The reconstruction means 32 receive partial information items 132 extracted by the processing means 31. Over the course of the period T, the reconstruction means 32 combine information from each partial information item 132 thereby received to generate the complete, aggregated information item (the public key 111 or the system signature). The reconstruction means 32 therefore implement the threshold-based cryptographic scheme reciprocal to this one used to generate partial information items 132. In the first modality, an interpolation method may be used; in the second modality, it may be the means defined in the threshold-based signature scheme. The reconstruction means 32 can only accomplish this task if the number of partial information items 132 is greater than or equal to the threshold value K.

Each device according to the verification invention 3 includes validation means 33 for each signature 133 paired with the reconstruction means 32 that transmit the public key 111 to them. The validation means 33 for each signature 133 are also paired with the decoding means 31 that especially transmit to them shared information items, information items specific to the transmission device 2 at the origin of said message MSG and each signature 133. The validation means 33 then verify with the help of the public key 111 that each signature 133 is valid. If the signature 133 is valid, the validation means 33 release an information item guaranteeing that the signals S received are considered as having been transmitted by a set of trust transmission devices 2. If the signature 133 is not valid or if the signature 133 cannot be verified, particularly because it has not been possible for the reconstruction means 32 to supply the public key 111, the validation means 33 release an information item indicating that it is not possible to guarantee that the signals S received have been transmitted by trust transmission devices 2. Each verification device 3 according to the invention may furthermore include means of constructing 35 the application message MSG_APPLI and an application interface 34, through which the construction means 34 release the application message MSG_APPLI if the validation means 33 have supplied an information item guaranteeing that the signals S received are considered to have been transmitted by trust transmitters 2.

In a first embodiment, the message MSG_APPLI is constructed from information items obtained following processing of the set of signals S received (such as, for example, information items on position/speed/time obtained by processing at least four signals S in a radio navigation system), the signature 133 of these information items and also, optionally, the public key 111, in order to create a verifiable certificate.

In a second embodiment, the message MSG_APPLI is constructed from the information items obtained following processing of the set of signals S received, the signature 133, the public key 111 and an aggregate signature SIGN_APPLI obtained from the SIGN signature, from the public key 111 and from a private key 35 specific to each verification device 3 according to the invention. The aggregate signatures are well known to the person skilled in the art, such a signature being described, for example, in the document “Aggregate and verifiably encrypted signatures from bilinear maps, D Boneh, C Gentry, B Lynn, H Shachan, Proceeding of EUROCRYPT 2003, LNCS-2656” pages 416 to 432 or also in the document “Batch verification of short signatures, J Camensich, S Hohenberger, M O Pedersen, EUROCRYPT 2007, LNCS 4515” on pages 246 to 263.

The system according to the invention may be a radio system implementing land-based and/or satellite means, including, particularly, an interior positioning system. The system according to the invention may also be used as a satellite navigation system, more commonly referred to using the acronym “GNSS” standing for Global Navigation Satellite System, more particularly a GALILEO system using the European Geostationary Navigation Overlay Service (EGNOS). In this case, the threshold value K is typically at least equal to 4 if the signals S come from satellite means. The threshold value K may, for example, be selected so as to be below half the number of satellites making up the constellation.

1. A method for transmitting messages (MSG) to guarantee the authenticity of the system that transmitted said messages (MSG), comprising:
selecting a threshold value (K) greater than or equal to 1;
generating a set of partial information items (132), such that knowledge of a number (i) of partial information items greater than or equal to the threshold value (K) makes it possible to verify a signature (133) of at least part of the messages (MSG); and
sending each partial information item separately in one of the distinct messages (MSG).

2. The method according to claim 1, in which the partial information items are partial keys generated such that knowledge of a number (i) of partial keys greater than or equal to the threshold value (K) enables a public key to be reconstructed, the signature being produced to be verifiable in relation to said public key, each message (MSG) including the signature of at least part of the said message (MSG).

3. The method according to claim 1, in which the partial information items are parts of the signature, such that knowledge of a number (i) of parts of the signature greater than or equal to the threshold value (K) enables the signature to be reconstructed, the signature being linked to the system and/or to at least part of the messages (MSG) common to the set of messages (MSG) over a given period.

4. The method according to claim 1, each partial information item including redundant data to detect and/or suppress transmission errors.

5. The method of verifying the authenticity of a system that transmitted messages (MSG) liable to be obtained by the method according to claim 1 further comprising:
receiving messages (MSG) including partial information items;
using the number (j) of partial information items received during the course of the step of receiving messages to reconstruct information items, enabling a signature of at least part of the messages (MSG) to be verified; and
if it has been possible to complete the step of reconstructing information items, verifying the signature of the messages (MSG).

6. A transmission device adapted to the implementation of the method according to claim 1, wherein it includes means of constructing and sending messages (MSG), each message (MSG) including at least a partial information item of a set generated so that knowledge of a number (i) of partial information items greater than or equal to a threshold value (K) makes it possible to verify a signature of at least part of the messages (MSG).

7. The device according to claim 6, in which the partial information items are partial keys, for which knowledge of a number (i) greater than or equal to the threshold value (K) makes it possible to reconstruct a public key, the signature being verifiable in relation to said public key, each message (MSG) including the signature of at least part of said message (MSG).

8. The device according to claim 6, in which partial information items are parts of the signature, for which knowledge of a number (i) greater than or equal to the threshold value (K) makes it possible to reconstruct the signature, the signature being linked to the system and/or to at least part of the messages (MSG) common to the set of messages over a given period.

9. A device for verifying the authenticity of a system adapted to the implementation of the method according to claim 5, wherein said device comprises:
decoding means adapted to receive messages (MSG) and extract partial information items from said messages (MSG) received;
means of reconstructing information items enabling at least one signature of at least part of the messages (MSG) to be verified from partial information items; and
validation means adapted to verifying the validity of each signature extracted in relation to messages (MSG) received.

10. A satellite radio navigation system including transmission devices according to claim 6 and at least one verification device.

11. The satellite radio navigation system according to claim 10, wherein the at least one verification device comprises:
decoding means adapted to receive messages (MSG) and extract partial information items from said messages (MSG) received;
means of reconstructing information items enabling at least one signature of at least part of the messages (MSG) to be verified from partial information items; and
validation means adapted to verifying the validity of each signature extracted in relation to messages (MSG) received.
